(19) United States
(12) Patent Application Publication
(10) Pub. No.: US 2016/0159379 A1
(43) Pub. Date: Jun. 9, 2016

(54) DATA COMMUNICATION SYSTEM FOR LOCOMOTIVE CONSIST

(71) Applicant: Electro-Motive Diesel, Inc., LaGrange, IL (US)

(72) Inventors: Benjamin A. Raeder, Mount Prospect, IL (US); Dennis Melas, Chicago, IL (US); Daniel E. Bechtlofft, Lemont, IL (US); Wayne A. Rudolph, Lemont, IL (US); Mark A. Fanara, Blue Springs, MO (US); Andrew J. Shakal, Bloomer, WI (US)

(73) Assignee: Electro-Motive Diesel, Inc., LaGrange, IL (US)

(21) Appl. No.: 14/564,166

(22) Filed: Dec. 9, 2014

(51) Int. Cl. B61L 15/00; G01F 23/00

(52) U.S. Cl. CPC B61L 15/0018; G01F 23/0007

(57) ABSTRACT

A data communication system for a locomotive consist is provided. The locomotive consist includes a primary unit and one or more secondary units. The data communication system includes a fuel level sensor associated with the secondary units. The fuel level sensor is configured to generate a signal indicative of a fuel level in a fuel reservoir of the respective secondary unit. The data communication system also includes a data controller communicably coupled to the fuel level sensor. The data controller is configured to receive the signal indicative of the fuel level in the fuel reservoir of the one or more secondary units. The data controller is also configured to compare the fuel level with a predetermined threshold. The data controller is further configured to determine if the fuel level of any of the one or more secondary units is lesser than the predetermined threshold.

### TECHNICAL FIELD

The present disclosure relates to a data communication system, and more particularly to the data communication system for a locomotive consist having a primary unit and one or more secondary units.

### BACKGROUND

A locomotive consist used for transportation purposes generally includes a lead locomotive and one or more trailing locomotives. In some examples, the lead locomotive has a power source installed thereon, for example, an engine for generating driving power to propel the locomotive consist on rails. However, in some cases, in addition to the lead locomotive, the one or more trailing locomotives may also have individual power sources associated therewith. The power source may either run on battery or fuel. In a situation wherein the locomotive consist is fuel operated, each of the lead locomotive and the trailing locomotives include a fuel reservoir to store the fuel therein.

An operator is generally seated in the lead locomotive for operating the locomotive consist. Accordingly, the operator may be unaware of operational data associated with each of the locomotives of the locomotive consist, since the operator is present at a remote location from these trailing locomotives. For example, in one situation, the operator may not be aware of a fuel level in the fuel reservoirs of each of the trailing locomotives. Low fuel level in the fuel reservoir of any of the trailing locomotives may have an overall impact on the operation of the locomotive consist and may even lead to stalling of the locomotive consist. The low fuel level may lead to damage of the engine and associated engine components of the respective locomotive.

U.S. Pat. No. 8,645,010 describes a system and method for communicating data in a locomotive consist or other vehicle consist in which a first electronic component in the first vehicle of the vehicle consist is monitored to determine if the component is in (or enters) a failure state. In the failure state, the first electronic component is unable to perform a designated function. Upon determining the failure state, data is transmitted from the first vehicle to a second electronic component on the second vehicle, over a communication channel linking the first vehicle and the second vehicle. The second electronic component is operated based on the transmitted data, with the second electronic component performing the designated function that the first electronic component is unable to perform.

### SUMMARY OF THE DISCLOSURE

In one aspect of the present disclosure, a data communication system for a locomotive consist is provided. The locomotive consist includes a primary unit and one or more secondary units. The data communication system includes a fuel level sensor associated with the one or more secondary units. The fuel level sensor is configured to generate a signal indicative of a fuel level in a fuel reservoir of the respective secondary unit. The data communication system also includes a data controller communicably coupled to the fuel level sensor. The data controller is configured to receive the signal indicative of the fuel level in the fuel reservoir of the one or more secondary units. The data controller is also configured to compare the fuel level with a predetermined threshold. The data controller is further configured to determine if the fuel level of any of the one or more secondary units is lesser than the predetermined threshold.

In another aspect of the present disclosure, a method for data communication in a locomotive consist is provided. The locomotive consist includes a primary unit and one or more secondary units. The method includes receiving a signal indicative of the fuel level in a fuel reservoir of the one or more secondary units. The method also includes comparing the fuel level with a predetermined threshold. The method further includes determining if the fuel level of any of the one or more secondary units is lesser than the predetermined threshold.

In yet another aspect of the present disclosure, a locomotive consist is provided. The locomotive consist includes a primary unit. The locomotive consist also includes one or more secondary units. The one or more secondary units has a fuel reservoir. The locomotive consist further includes a fuel level sensor associated with the one or more secondary units. The fuel level sensor is configured to generate a signal indicative of a fuel level in the fuel reservoir of the respective secondary unit. The locomotive consist includes a data controller communicably coupled to the fuel level sensor. The data controller is configured to receive the signal indicative of the fuel level in the fuel reservoir of the one or more secondary units. The data controller is also configured to compare the fuel level with a predetermined threshold. The data controller is further configured to determine if the fuel level of any of the one or more secondary units is lesser than the predetermined threshold.

Other features and aspects of this disclosure will be apparent from the following description and the accompanying drawings.

### BRIEF DESCRIPTION OF THE DRAWINGS

FIG. 1 is a schematic view of an exemplary locomotive consist, according to one embodiment of the present disclosure;

FIG. 2 is a block diagram of a data communication system for communication of fuel level within the locomotive consist of FIG. 1; and

FIG. 3 is a flowchart for a method of data communication within the locomotive consist.

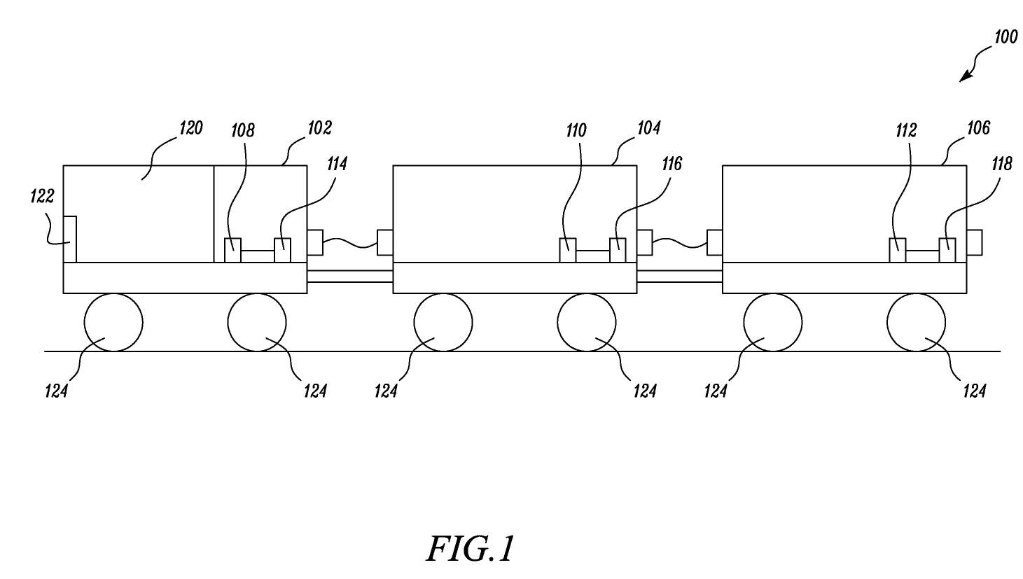

### DETAILED DESCRIPTION

Wherever possible, the same reference numbers will be used throughout the drawings to refer to the same or the like parts. FIG. 1 is a schematic view of an exemplary locomotive consist 100, according to one embodiment of the present disclosure. The term “locomotive consist” referred to herein may include a group of two or more locomotive units that are mechanically coupled and/or linked with each other to travel along a rail route. The locomotive consist 100 may be used for transportation of passengers and/or cargo. It should be noted that the application of the present disclosure is not restricted to the locomotive consist, and may be extended to any type of rail vehicles known to a person of ordinary skill in the art.

The locomotive consist 100 shown in the accompanying figures includes a primary unit 102. The locomotive consist 100 also includes a pair of secondary units 104, 106. Each of the primary and secondary units 102, 104, 106 are provided adjacent to and mechanically coupled with each other, such that the units 102, 104, 106 are connected as shown and are arranged one behind the other. The secondary units 104, 106 are embodied as trail units, and are coupled behind the primary unit 102; in a propulsion direction of the locomotive consist 100.

It should be noted that the number of primary and secondary units 102, 104, 106 disclosed herein is exemplary, and may vary based on the applications. For example, the locomotive consist 100 may include more than one primary unit 102. Further, the locomotive consist 100 may also include more than a pair of secondary units 104, 106. Based on the type of application, the secondary units 104, 106 of the locomotive consist 100 may embody any one of a passenger car, a freight car, or a combination thereof. In alternate embodiments, the locomotive consist 100 may include a plurality of subset locomotive consists. Each of the subset locomotive consists may further include or more primary and secondary units.

It should be noted that the locomotive consist 100 may include connection mechanisms (not shown) that couple power and brake systems of the primary and secondary units 102, 104, 106 with each other, for functioning as a single unit or unitary entity. Each of the primary and secondary units 102, 104, 106 of the locomotive consist 100 may respectively include an engine 108, 110, 112 associated therewith. The engine 108, 110, 112 is configured to provide driving power to the locomotive consist 100 in order to propel the locomotive consist 100. In one embodiment, the engine 108, 110, 112 may include, for example, a diesel engine, a gasoline engine, a gaseous fuel powered engine such as, a natural gas engine, a combination of known sources of power, or any other type of power source apparent to one of skill in the art.

The engines 108, 110, 112 of each of the primary unit 102 and the secondary units 104, 106 respectively include a fuel reservoir 114, 116, 118 associated therewith. The fuel reservoirs 114, 116, 118 are configured to hold and supply fuel to the respective engines 108, 110, 112 for combustion purposes. It should be noted that the fuel requirements of each of the engines 108, 110, 112 may vary, and therefore fuel capacity and size of each of the fuel reservoirs 114, 116, 118 also vary with respect to each other.

The locomotive consist 100 includes at least one operator cab 120 for an operator to be present in for operating the locomotive consist 100. In the illustrated embodiment, the primary unit 102 of the locomotive consist 100 includes the operator cab 120. The operator cab 120 may include an operator interface 122. The operator interface 122 may be, for example, a gauge or a console to display speed of the locomotive consist 100. The operator interface 122 may be embodied as any other input and/or output device such as a touchscreen, a LCD panel, a screen, a monitor to provide notifications to the operator of operational parameters associated with the locomotive consist 100.

The operator interface 122 may also include a steering control mechanism, which may be communicably coupled to a propulsion system of the locomotive consist 100. The operator may operate the steering control mechanism to maneuver the locomotive consist 100. The operator interface 122 may further include a plurality of input devices in addition to those mentioned above for controlling the locomotive consist 100 and to perform various operations thereon, without limiting the scope of the present disclosure. The locomotive consist 100 may also include a braking arrangement (not shown) to halt a movement of the locomotive consist 100. The braking arrangement may include a foot activated brake pedal provided in the operator cab 120. Alternatively, the braking arrangement may include a hand operated lever provided on the operator interface 122. The locomotive consist 100 also includes a plurality of wheels 124 for propulsion of the locomotive consist 100 on the rail route.

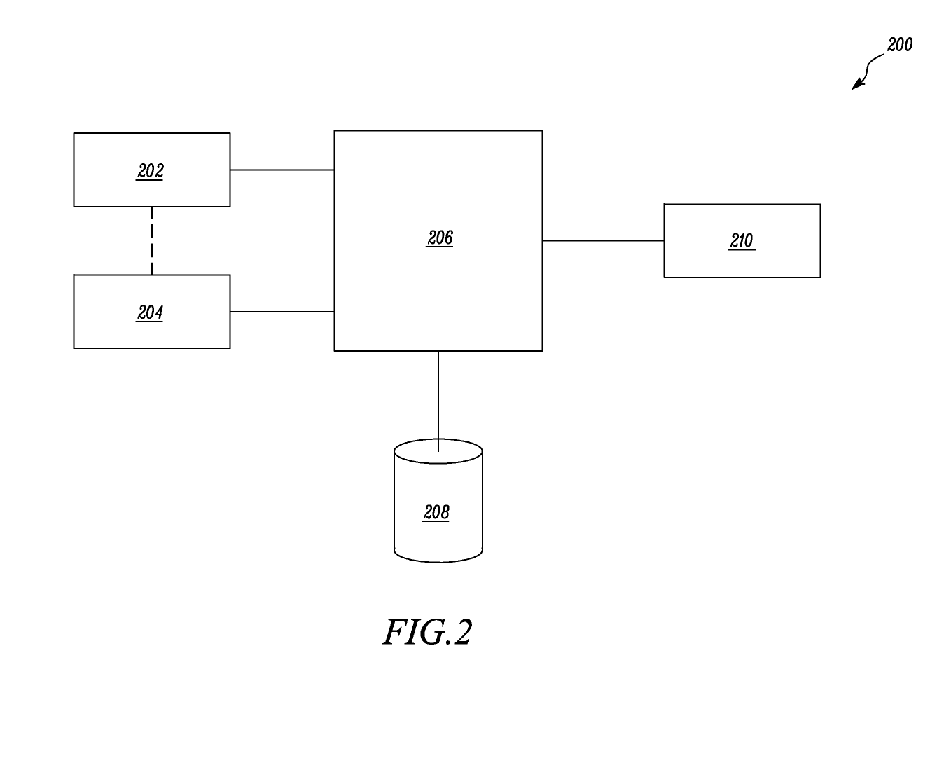

The present disclosure relates to a data communication system 200 associated with the locomotive consist 100. The data communication system 200 is configured to identify and notify the operator regarding a fuel level in the fuel reservoirs 116, 118 of the secondary units 104, 106. The working of the data communication system 200 will now be explained in connection with FIG. 2.

FIG. 2 illustrates a block diagram of the exemplary data communication system 200. The data communication system 200 includes a fuel level sensor 202, 204 associated with each of the secondary units 104, 106 of the locomotive consist 100 (see FIG. 1). The fuel level sensor 202, 204 is configured to generate a signal indicative of the fuel level in the fuel reservoir 116, 118 of the respective secondary units 104, 106. As illustrated in the accompanying figures, two fuel level sensors 202, 204 are associated with the data communication system 200. More particularly, each of the secondary units 104, 106 of the locomotive consist 100 includes a fuel level sensor 202, 204 provided therewith. In alternate embodiments, the fuel level sensor may be present in at least one of the secondary units of the locomotive consist 100. It should be noted that the number of the fuel level sensors may vary based on the number of the secondary units associated with the locomotive consist.

The fuel level sensor 202, 204 may include any of a known level sensor which may be used for fluid level detection. The fuel level sensor 202, 204 may embody a contact type level sensor or a contactless type level sensor, based on the type of application. In one example, the fuel level sensor 202, 204 may include a mechanical float. Alternatively, the fuel level sensor 202, 204 may include a Radio Frequency (RF) sensor or an ultrasonic sensor. It should be noted that any other type of sensor may be used for measuring the fuel level within the fuel reservoirs 116, 118 without limiting the scope of the present disclosure.

The data communication system 200 includes a data controller 206. The data controller 206 is communicably coupled to the fuel level sensor 202, 204 of the respective secondary units 104, 106. The communication between the fuel level sensor 202, 204 and the data controller 206 may be wired or wireless, based on the type of application. Further, the data controller 206 may be located on-board the locomotive consist 100. In one embodiment, the data controller 206 may be present in the primary unit 102 of the locomotive consist 100. In alternate embodiments, the data controller 206 may be present at a remote location, for example, at a base station.

The data controller 206 is configured to receive a signal indicative of the fuel level in the fuel reservoir 116, 118 of the respective secondary unit 104, 106 from the fuel level sensors 202, 204. Further, a database 208 may be communicably coupled to the data controller 206 in a wired or wireless manner. In one example, the database 208 may store predetermined thresholds corresponding to a fuel level required in the fuel reservoirs 116, 118 of the respective secondary units 104, 106. The term “predetermined threshold” disclosed herein relates to the fuel level that may need to be maintained in each of the fuel reservoirs 116, 118, in order to meet the fuel requirements of the respective engines 110, 112. In one example, the predetermined thresholds for each of the fuel reservoirs 116, 118 of the locomotive consist 100 may be same. However, in some embodiments, the predetermined thresholds for the fuel level in each of the fuel reservoirs 116, 118 may vary based on the fuel requirements and engine capacity of the respective engine 110, 112. In such a situation, the database 208 may store different predetermined thresholds for the fuel level for the respective fuel reservoirs 116, 118.

The location of the database 208 may vary based on the application. The predetermined thresholds stored within the database 208 may be retrieved from any external source(s) and/or updated on a real time basis. The database 208 may be any conventional or non-conventional database known in the art. Moreover, the database 208 may be capable of storing and/or modifying pre-stored data as per operational and design needs.

The data controller 206 is configured to retrieve the information of the predetermined threshold of the fuel level associated with the secondary units 104, 106 from the database 208. The data controller 206 may compare the signal received from the fuel level sensor 202, 204 associated with the secondary units 104, 106 with the respective predetermined threshold for the given secondary unit 104, 106. Further, the data controller 206 may determine whether the fuel level in the respective fuel reservoir 116, 118 is lesser than the respective predetermined threshold. In a situation wherein the detected fuel level in any of the fuel reservoirs 116, 118 is lesser than the predetermined threshold, the data controller 206 triggers an alert notification in order to inform the operator of a low fuel level in the given secondary unit 104, 106.

The alert notification may be provided via an output module 210. The output module 210 is communicably coupled to the data controller 206 in a wired or wireless manner. The output module 210 is configured to receive information of the identified fuel level from the data controller 206. The output module 210 is also configured to provide an indication to the operator, of the identified fuel level in the fuel reservoirs 116, 118. The output module 210 may be mounted at a location such that the output module 210 may be viewable to the operator. In one embodiment, the output module 210 may be present at the primary unit 102. For example, the output module 210 may be present in the operator cab 120 of the locomotive consist 100. Alternatively, the output module 210 may be positioned at one or both of the secondary units 104, 106 of the locomotive consist 100. The output module 210 may also be present at a location external to the locomotive consist 100, for example, at the remote location, such as, a base station.

The output module 210 may embody a visual output or an audio output. In one example, wherein the output module 210 is embodied as a visual output, the output module 210 may include any one of a digital display device, an LCD device, an LED device, a CRT monitor, a touchscreen device, or any other display device known in the art. In one example, the output module 210 may notify the operator regarding the identified fuel level through a text message.

Alternatively, the output module 210 may include an indicator light. An LED light, an LCD light, or an infrared light may be used to alert the operator of the fuel level. For example, if the fuel level in the respective fuel reservoir 116, 118 of the secondary unit 104, 106 is greater than the predetermined threshold, the indicator light may glow of a green color, indicating to the operator that the fuel level in the given secondary unit 104, 106 is within operational limits or requirements. In another example, if the fuel level in the respective fuel reservoir 116, 118 of the secondary unit 104, 106 is lesser than the predetermined threshold, the indicator light may glow of a red color indicating to the operator that the fuel level in the given secondary unit 104, 106 is lesser than the operational requirements.

In a situation wherein the output module 210 is embodied as the audio output, an audio clip may be heard, thereby alerting the operator of the fuel level. It should be noted that the output module 210 may include any other means other than those listed above.

The data controller 206 may embody a single microprocessor or multiple microprocessors for receiving signals from components of the data communication system 200. Numerous commercially available microprocessors may be configured to perform the functions of the data controller 206. It should be appreciated that the data controller 206 may embody a machine microprocessor capable of controlling numerous machine functions. A person of ordinary skill in the art will appreciate that the data controller 206 may additionally include other components and may also perform other functions not described herein.

### INDUSTRIAL APPLICABILITY

Locomotive consists generally include a plurality of units provided and coupled adjacent to each other. Each of the units of the locomotive consist include an engine and a fuel reservoir associated therewith. Further, an operator of the locomotive consist is generally present in a lead unit of the locomotive consist. Therefore, the operator may not be aware of a level of fuel in the fuel reservoirs present in trailing units. In a situation wherein the level of fuel in the fuel reservoirs is less than a threshold fuel level, fuel requirements of the engine will not be met. This may lead to an inefficient operation of the engine and may also stop the engine functionality in some cases. In some situations, low fuel levels may cause irreparable damage to engine components, such as a fuel injector.

The present disclosure relates to the data communication system 200 for the locomotive consist 100. The data communication system 200 is configured to alert the operator of the fuel level in the fuel reservoirs 116, 118 of the secondary units 104, 106. This will prevent any potential damage to the engines 110, 112 that may arise if the fuel reservoirs 116, 118 of the secondary units 104, 106 run dry. Accordingly, there will be a reduced possibility of the locomotive consist 100 to encounter an on-site failure, thereby increasing a reliability of the locomotive consist 100. The data communication system 200 of the present disclosure may be retrofitted to an existing locomotive consist 100.

Based on the fuel requirements of the respective engine 110, 112, the predetermined thresholds corresponding to the respective fuel reservoirs 116, 118 of the secondary units 104, 106 may be different from each other. The data communication system 200 disclosed herein is capable of detecting and comparing the fuel levels in the fuel reservoirs 116, 118 with the respective predetermined threshold. Further, based on the comparison, the data communication system 200 is configured to display whether or not the fuel levels in the fuel reservoirs 116, 118 meets with the fuel requirements of the respective engine 110, 112.

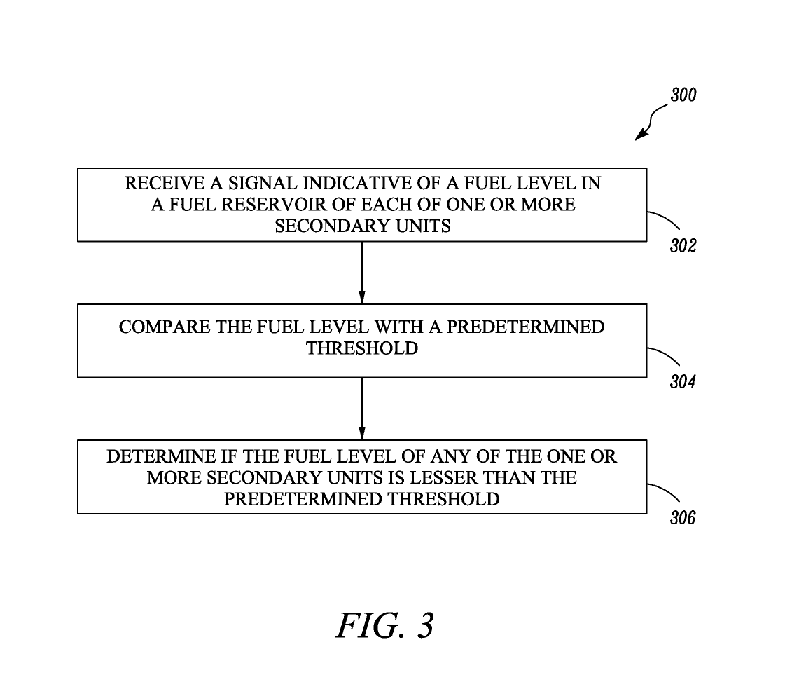

FIG. 3 is flowchart for a method 300 of data communication in the locomotive consist 100. The locomotive consist 100 includes the primary unit 102 and one or more secondary units 104, 106. At step 302, the data controller 206 is configured to receive the signal indicative of the fuel level in the respective fuel reservoirs 116, 118 of the secondary units 104, 106. At step 304, the data controller 206 is configured to compare the fuel level within the fuel reservoirs 116, 118 with the predetermined threshold.

At step 304, the data controller 206 is configured to determine if the fuel level of any of the secondary units 104, 106 is lesser than the predetermined threshold. In a situation wherein the fuel level of the respective secondary units 104, 106 is lesser than the predetermined threshold, the data controller 206 is configured to trigger the alert notification on the output module 210. In some situations, the output module 210 is also configured to display the fuel level information within the fuel reservoirs 116, 118 as and when requested by the operator.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A data communication system for a locomotive consist, the locomotive consist having a primary unit and one or more secondary units, the data communication system comprising:
a fuel level sensor associated with the one or more secondary units, the fuel level sensor configured to generate a signal indicative of a fuel level in a fuel reservoir of the respective secondary unit; and
a data controller communicably coupled to the fuel level sensor, the data controller configured to:
receive the signal indicative of the fuel level in the fuel reservoir of the one or more secondary units;
compare the fuel level with a predetermined threshold; and
determine if the fuel level of any of the one or more secondary units is lesser than the predetermined threshold.

2. The data communication system of claim 1 further comprising an output module communicably coupled to the data controller.

3. The data communication system of claim 2, wherein the output module is present at the primary unit.

4. The data communication system of claim 2, wherein the data controller is further configured to trigger an alert on the output module if the fuel level of any of the one or more secondary units is lesser than the predetermined threshold.

5. The data communication system of claim 2, wherein the output module is present at a remote location.

6. The data communication system of claim 2, wherein the output module includes at least one of a display unit and an indicator light.

7. The data communication system of claim 2, wherein the output module is present at the one or more secondary units.

8. A method for data communication in a locomotive consist, the locomotive consist having a primary unit and one or more secondary units, the method comprising:
receiving a signal indicative of the fuel level in a fuel reservoir of the one or more secondary units;
comparing the fuel level with a predetermined threshold; and
determining if the fuel level of any of the one or more secondary units is lesser than the predetermined threshold.

9. The method of claim 8 further comprising:
triggering an alert on an output module if the fuel level of any of the one or more secondary units is lesser than the predetermined threshold.

10. A locomotive consist comprising:
a primary unit;
one or more secondary units, the one or more secondary units having a fuel reservoir;
a fuel level sensor associated with the one or more secondary units, the fuel level sensor configured to generate a signal indicative of a fuel level in the fuel reservoir of the respective secondary unit; and
a data controller communicably coupled to the fuel level sensor, the data controller configured to:
receive the signal indicative of the fuel level in the fuel reservoir of the one or more secondary units;
compare the fuel level with a predetermined threshold; and
determine if the fuel level of any of the one or more secondary units is lesser than the predetermined threshold.

11. The locomotive consist of claim 10 further comprising an output module communicably coupled to the data controller.

12. The locomotive consist of claim 11, wherein the output module is present at the primary unit.

13. The locomotive consist of claim 11, wherein the data controller is further configured to trigger an alert on the output module if the fuel level of any of the one or more secondary units is lesser than the predetermined threshold.

14. The locomotive consist of claim 11, wherein the output module is present at a remote location.

15. The locomotive consist of claim 11, wherein the output module includes at least one of a display unit and an indicator light.

16. The locomotive consist of claim 11, wherein the output module is present at the one or more secondary units.
